(19) United States
(12) Patent Application Publication
(10) Pub. No.: US 2026/0223148 A1
(43) Pub. Date: Jul. 30, 2026

(54) VIRTUAL POINT OF INTERFACE FOR MULTI-OPERATOR RADIO ACCESS NETWORK HAVING VIRTUAL RADIOS

(71) Applicant: JOHN MEZZALINGUA ASSOCIATES, LLC., Liverpool, NY (US)

(72) Inventors: Massimo NOTARGIACOMO, Castel Bolognese (IT); Jeffrey Tony MASTERS, Ocala, FL (US); Roberto ORLANDINI, Budrio (IT); Jeffrey COURINGTON, Chester, IL (US)

(21) Appl. No.: 19/143,324

(22) PCT Filed: Dec. 4, 2024
(86) PCT No.: PCT/US2024/058459

§ 371 Date: Jun. 25, 2025

Related U.S. Application Data
(60) Provisional application No. 63/606,943, filed on Dec. 6, 2023.

(51) Int. Cl. H04W 72/51; H04W 72/0453; H04W 72/0457

(52) U.S. Cl. CPC H04W 72/51; H04W 72/0453; H04W 72/0457

(57) ABSTRACT

A multi-operator RAN (Radio Access Network) has a controller with a virtual POI (Point of Interface). Each network operator has an O-DU (O-RAN Distributed Unit) that is coupled to an element manager that interacts with the virtual POI via a set of APIs (Application Program Interface). The controller allocates radio resources within each of a plurality of O-RUs (O-RAN Remote Units) to each of the network operators, defining a plurality of virtual radios-one per network operator-such that each O-DU interacts only with the allocated radio resources exposed to it by the controller.

### BACKGROUND OF THE INVENTION

Modern RAN (Radio Access Network) technologies, such as that described by the O-RAN (Open RAN) consortium, provide for a DU (Direct Unit) of a 5G gNodeB to be connected to multiple RUs (Remote Units). However, conventional approaches only apply to scenarios with a single DU belonging to a single network operator. They do not provide for the capability for multiple DUS, each belonging to a distinct network operator, to share a plurality of RUs.

Accordingly, what is needed is a RAN that enables multiple network operators to use a single set of RUs, such as in a private network, with none of the network operators'actions affecting the other network operators sharing the RAN.

### SUMMARY OF THE INVENTION

An aspect of the disclosure involves a method for configuring a multi-operator RAN. The method comprises receiving, from each of a plurality of remote units, a set of capabilities of the remote unit; allocating radio resources from each set of capabilities of the plurality of remote units, across each of a plurality of network operators to define a set of allocated radio resources for each of the network operators; defining and coupling a virtual radio to each of a plurality of element managers, wherein each element manager is coupled to a distributed unit corresponding to one of the plurality of network operators; and configuring each of the remote units to couple to each of the plurality of distributed units in accordance with the plurality of virtual radios.

Another aspect of the disclosure involves a method for configuring a remote unit in a multi-operator radio access network. The method comprises receiving a plurality of configuration commands from a controller, the configuration commands for configuring each of a plurality of RF (Radio Frequency) resource pools; and receiving a distributed unit address for each of the plurality of RF resource pools.

### BRIEF DESCRIPTION OF DRAWINGS

FIG. 1 illustrates an exemplary RAN having a virtual POI according to the disclosure.

FIG. 2 illustrates an exemplary O-RU according to the disclosure.

FIG. 3 illustrates an exemplary process for configuring and operating an exemplary RAN having a virtual POI according to the disclosure.

### DETAILED DESCRIPTION OF THE INVENTION

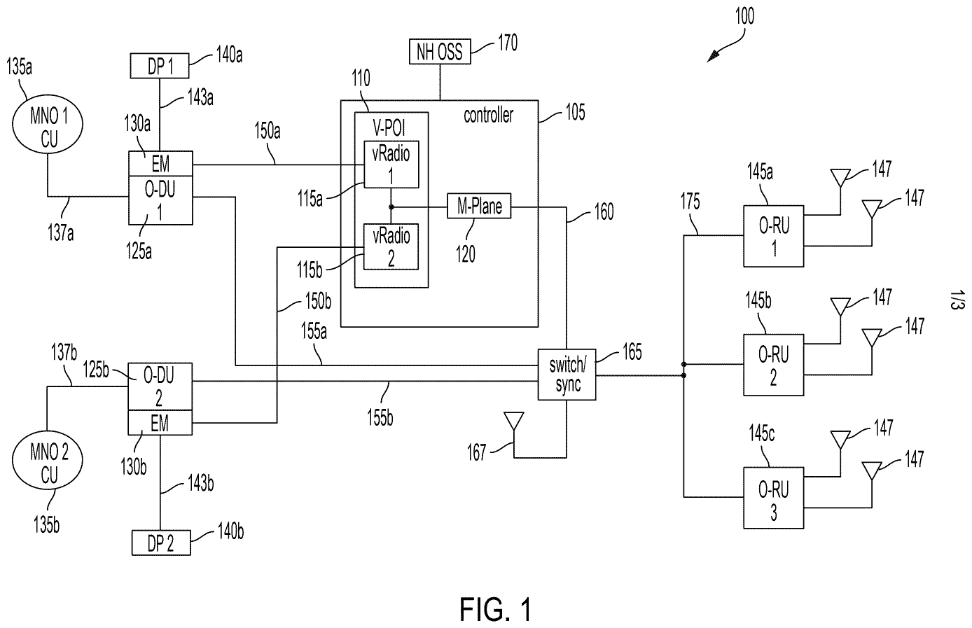

FIG. 1 illustrates an exemplary RAN 100 according to the disclosure. RAN 100 has a controller 105 that is coupled to a plurality of element managers 130a and 130b, each of which is coupled to an O-DU (Open Radio Access Network-Distributed Unit) 125a and 125b. Each O-DU 125a/b may be implemented as Distributed Units as defined by the 5G NR (New Radio) specification and the O-RAN specification. Each O-DU 125a/b may be coupled to a corresponding 5G CU (Centralized Unit) 135a/b, operated by a network operator, over an F1 interface 137a/b.

Controller 105 is coupled to switch/sync module 165 over an M-Plane network 160. Switch/sync module 165 is coupled to the O-DUs 125a/b over respective control/user plane networks 155a/b, and to a plurality of O-RUs (O-RAN Remote Units) 145a/b/c over a fronthaul network 175. Each of the O-RUs 145a/b/c may be coupled to one or more antennas 147.

As illustrated, some components of RAN 100 have multiple instances (e.g., O-RU 145a/b/c, element manager 130a/b, etc.). As used herein, a singular reference to that component (e.g., O-RU 145, element manager 130) pertains to any of those components, generally.

RAN 100 may have a neutral host operation support system 170, which may be a software module or aggregate of software modules that manages the configuration and operation of controller 105, switch/sync module 165, and O-RUs 145 and their interactions with element managers 130 and their respective O-DUs 125. Neutral Host OSS 170 may be hosted on the same server hardware as controller 105 or may be hosted remotely.

Controller 105 includes a virtual POI 110 that hosts a plurality of virtual radios 115 (one per corresponding element manager 130) and an M-Plane interface 120. Controller 105 may have one or more processors (not shown) that execute instructions to instantiate and implement virtual POI 110, its virtual radios 115, and M-Plane interface 120. Virtual POI 110 may be coupled to a plurality of element managers 130 over a proprietary interface 150 that may be implemented over an Ethernet network. An example of proprietary interface 150 may be a REST (Representational State Transfer) interface. Controller 105 may communicate with O-RUs 145 via M-Plane interface 120 over an M-Plane network 160, described further below.

As used herein, the term “network operator” may refer to a conventional MNO (Mobile Network operator) and/or to a private network or entity that operates one or more 5G gNodeBs.

M-Plane interface 120 may be coupled to a plurality of O-RUs (O-RAN Remote Unit) 145 over an M-Plane network 160, which may be an Ethernet network. As illustrated, M-Plane network 160 couples M-Plane interface 120 to switch/sync module 165. The M-Plane traffic carried by M-Plane network 160 is carried over fronthaul network 175 along with other packet traffic, as is described below.

Each O-RU 145 may communicate with M-Plane interface 120 over an individual socket implemented over an Ethernet network (M-Plane network 160 and fronthaul network 175). M-Plane interface 120 and M-Plane network 160 may be a management plane implementation described in the O-RAN specification. It is through M-Plane interface 120 and M-Plane network 160 that controller 105 may configure and manage the radios within each O-RU 145, and through which each O-RU 145 may provide performance measurement and alarm information to controller 105.

Virtual POI 110 is a software module, or layer, that provides a single interface by which each network operator (via its element manager 130) may gain access to RAN 100. Virtual POI 110 provides a plurality of APIs (Application Programming Interface) to the element managers 130 for this to occur. Through virtual POI 110, controller 105 may instantiate a virtual radio 115 that corresponding element manager 130 may interact with to establish and maintain communication with its allocated radio resources distributed among O-RUs 145. With communications established element manager 130 may receive alarms and performance information pertaining to the radio resources allocated to it. This is described in more detail below.

Element managers 130 use APIs made available by virtual POI 110. Through the APIs, each element manager 130 executes instructions to learn the capabilities of RAN 100, specifically, the capabilities within each of the O-RUs 145 that virtual POI 110 exposes to that particular element manager 130; to establish communications with controller 105 through virtual POI 110; to request a list of compatible resources within RAN 100; to request a mapping to compatible resources allocated to it by controller 105, thereby defining a virtual radio 115; to retrieve information pertaining to its virtual radio 115, and to receive alarm and performance information from its virtual radio 115. Once the resource mapping is complete, each respective O-DU 125 may begin sending radio samples to (and receive samples from) the radio resources within the O-RUs 145, defined by virtual radio 115, which are exposed to it by controller 105. The process by which this happens is described below.

Each element manager 130 may be integrated into or coupled to its corresponding O-DU (O-RAN Distributed Unit) 125 that is in turn coupled to its corresponding CU (Centralized Unit) 135 of its network operator over an F1 interface 137.

Each of the element managers 130 may be coupled to a respective CBRS (Citizens Broadband Radio Service) domain proxy 140 over a network connection 143. With this arrangement, each O-DU 125, via its corresponding element manager 130, may interact with a CBRS SAS (Spectrum Allocation Service-not shown) to request and receive grants to different CBRS channels allocated by controller 105 to its virtual radio 115. This may happen independently of controller 105.

Switch/sync module 165 may include a GPS receiver (not shown) that is coupled to a GPS antenna 167. Through the time synchronization offered by the integrated GPS receiver, switch/sync module 165 may synchronize the O-DUs 145 with each other and with the O-RUs 145. This may be done by known methods.

As used here, the term “software module” or “module” may refer to a set of machine-readable instructions that are encoded within one or more non-transitory memory devices and executed on one or more processors that host the illustrated components, including virtual POI 110, virtual radios 115, M-Plane interface 120, element managers 130, switch/sync module 165, and software components within each O-RU 145 (described below). As used herein, the term “non-transitory memory” may refer to any tangible storage medium (as opposed to an electromagnetic or optical signal) and refer to the medium itself, and not to a limitation on data storage (e.g., RAM vs. ROM). For example, non-transitory medium may refer to an embedded memory that is encoded with instructions whereby the memory may have to be re-loaded with the appropriate machine-readable instructions after being power cycled. Further, if an action is described herein as being done by a referenced module (e.g., “e.g., controller 105 stores the data . . . ”), it will be understood that this may describe one or more processors executing the module's machine-readable instructions to perform that particular action. Further, the processors within controller 105 and O-RUs 145 may be servers or embedded processors or may include FPGAs (Field Programmable Gate Array).

Although exemplary RAN 100, as illustrated, has three O-RUs 145 and hosts two network operators, it will be understood that RAN 100 may include more network operators (via their corresponding element O-DUs 125 and element managers 130 as well as more or fewer O-RUs 145. Further, although control/user plane networks 155, proprietary interfaces 150, M-Plane network 160, and fronthaul network 175 are illustrated as separate connections, it will be understood that these illustrated connections may be logical connections and that control/user plane networks 155, M-Plane network 160, and fronthaul network 175, may be implemented via packetized traffic over a single Ethernet network.

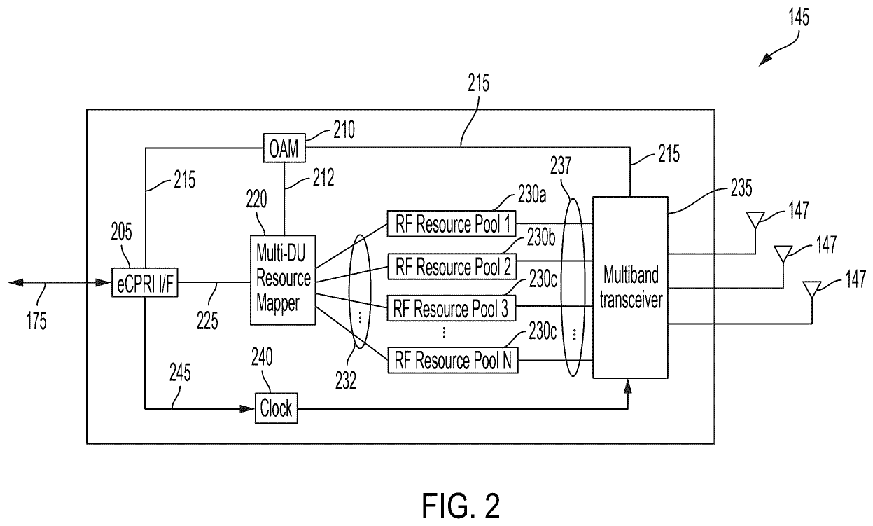

FIG. 2 illustrates an exemplary O-RU 145 according to the disclosure. O-RU 145 has an eCPRI (enhanced Common Public Radio Interface) interface 205 that couples to fronthaul network 175; a multi-DU resource mapper 220 that is coupled to eCPRI interface 205 over a control/user plane bus 225; an OAM (Operation and Management) module 210 that is coupled to eCPRI interface 205 over an M-Plane bus 215, to multi-DU resource mapper 220 over data connection 212, and to multiband transceiver 235 over M-Plane bus 215; and a plurality of RF resource pools 230, each of which is coupled to multi-DU resource mapper 220 over a dedicated control/user plane connection 232. Each of the plurality of RF resource pools 230 is coupled to a multiband transceiver 235 over a dedicated RF connection 237. O-RU 145 further has a clock processor 240 that is coupled to eCPRI interface 205 and to multiband transceiver 235 over a synchronization plane connection 245. Multiband transceiver 235 is coupled to one or more antennas 147.

eCPRI interface 205 receives control packets and data packets from the O-DUs 125 coupled to it over control/user plane networks 155 through switch/sync module 165 and fronthaul network 175, and routes the control and data packets between each O-DU 125 and multi-DU resource mapper 220. The control and data packets may be implemented according to the 7.2x split defined by the O-RAN specification. eCPRI interface 205 also relays M-Plane packets between M-Plane interface 120 (over M-Plane network 160, switch/sync module 165, and fronthaul network 175) and OAM module 210. eCPRI interface 205 further relays clock synchronization information from switch/sync module 165 with clock processor 240, which in turn synchronizes multiband transceiver 235 with the O-DUs 125.

Multi-DU resource mapper 220 maps uplink and downlink 7.2x control and data packets between each RF resource pool 230 and the O-DU 125 to which the given RF resource pool 230 is allocated by controller 105 as part of its virtual radio 115. Multi-DU resource mapper 220 receives mapping information from, and acts as an agent of, controller 105 via OAM 210. Multi-DU resource mapper 220 may maintain a table of addresses for each RF resource pool 230 that it maps to the addresses of each O-DU 125 so that the uplink and downlink 7.2x packets may be routed between a given O-DU 125 and its allocated component carrier handled by RF resource pool 230, as specified by its virtual radio 115.

Each RF resource pool 230 has a software module that implements Lower PHY (Physical Layer) processing, as defined by the O-RAN specification, for a given component carrier within a frequency band supported by multiband transceiver 235. Each resource pool 230 may be implemented, all or in part, in an FPGA (Field Programmable Gate Array). An FPGA implementation may also perform digital RF-to-baseband frequency down-conversion and analog-to-digital conversion in the uplink; and digital-to-analog conversion and baseband-to-RF frequency up-conversion in the downlink. Alternatively, RF resource pool 230 may have analog circuitry that performs RF-to-baseband frequency down-conversion and analog-to-digital conversion in the uplink; and digital-to-analog conversion and baseband-to-RF frequency up-conversion in the downlink. It will be understood that such variations are possible and within the scope of the disclosure.

In the downlink, each RF resource pool 230 receives the 7.2x packets from its assigned O-DU 125 (and routed to it by multi-DU resource mapper 220), processes the data packets, and populates a downlink component carrier resource grid with samples received from the O-DU 125 according to the 7.2x control plane information received from the O-DU's MAC (Medium Access Control) scheduler. Each RF resource pool 230 then converts the resource grid data into a modulated RF signal that it then provides to multiband transceiver 235 over dedicated RF connection 237. Multiband transceiver 235 then combines the modulated RF signals from each of the RF resource pools 230 that share a frequency band, amplifies the combined signal, and transmits it over the air via antenna 147. It will be understood how each RF resource pool 230 may perform the lower PHY processing in the reverse for uplink processing. In the uplink, each RF resource pool 230 receives an analog RF signal, filtered to its designated component carrier frequency, from multiband transceiver 235. RF resource pool 230 performs the frequency down-conversion, analog/digital conversion, demodulation, and other O-RAN-specified lower PHY processing to generate an uplink component carrier resource grid. RF resource pool 230 then packetizes the resource grid into 7-2x data packets that it relays to multi-DU resource mapper 220, which in turn routes the packetized data to the O-DU 125 assigned to it according to its virtual radio 115. Each RF resource pool 230 may also obtain and process performance measurement information regarding its lower PHY processing.

Multiband transceiver 235 may support multiple frequency bands. In an example, each O-RU 145 in RAN 100 may be configured to operate in three frequency bands: band 1, band 2, and band 48 (for CBRS). For example, band 1 may be one used in LTE/4G and band 2 may be one used in 5G. In this case, multiband transceiver 235 may have three independent radios, each having a power amplifier (for transmitting) and low noise amplifier (for receiving) designed for that frequency band. Further to this example, O-RU 145 may be configured so that the plurality of RF resource pools 230 may be divided into three subsets, each assigned to a given frequency band, and each RF resource pool 230 coupled to its appropriate radio within multiband transceiver 235 by its dedicated RF connection 237. This configuration process may be done by OAM 210, executing commands provided to it from controller 105 from M-Plane interface 120 via intervening networks and eCPRI interface 205.

OAM 210 may be configured to monitor multiband transceiver 235 for alarms pertaining to the health and function of the radios within multiband processor 235, such as temperature or power anomalies. On receipt of an alarm, OAM 210 relays the alarm to controller 105 (over M-Plane connection 215, through eCPRI interface 205, fronthaul network 175, switch/sync module 165, M-Plane network 160, and M-Plane interface 120). OAM 210 may include information regarding the O-RU 145 and frequency band and radio issuing the alarm. Using this information, controller 105 may relay the alarm to the affected element managers 130 (and thus their corresponding O-DU 125) via its virtual POI 110.

OAM 210 may further be configured to obtain performance measurement information corresponding to each RF resource pool 230. Performance measurement information may include network traffic anomalies or decoding/demodulation anomalies occurring in lower PHY processing of each RF resource pool 230. OAM 210 may gather performance metric information from each RF resource pool 230 and relay this information over the M-Plane to controller 105, which may in turn relay this information to the element manager 130 of the O-DU 125 assigned to the given RF resource pool 230 via its virtual radio 115.

Accordingly, RAN 100 may be configured so that each network operator (via its corresponding O-DU 125 and element manager 130) may be assigned a virtual radio 115 defined by controller 105. Each virtual radio 115 may map to a specific set of RF resource pools 230 distributed throughout the O-RUs 145. This may be done whereby controller 105, via virtual radio 115, may expose to a given O-DU 125 pre-determined component carriers (RF resource pools 230) within different frequency bands (supported by multiband transceiver 235) within each O-RU 145. Each network operator will only be aware of the resources (O-RU/band/component carrier) that controller 105 exposes to it via its virtual radio 115.

For example, MNO 1's virtual radio 115a may be assigned the following resources in O-RUs 145a, 145b, and 145c: RF resource pool 1 230a in band 1; and RF resource pool 3 230c in band 2; and RF resource pool 5 230e in band 48; and MNO 2's virtual radio 115b may be assigned the following resources in O-RUs 145a, 145b, and 145c: RF resource pool 2 230b in band 1; RF resource pool 4 230d in band 2; and RF resource pool 6 230f in band 48. It will be understood that different virtual radios 115 mappings are possible and within the scope of the disclosure.

Further, it will be understood that more network operators may be hosted by RAN 100, each with its own element manager 130 and assigned virtual radio 115, and that more O-RUs 145 may be present as well.

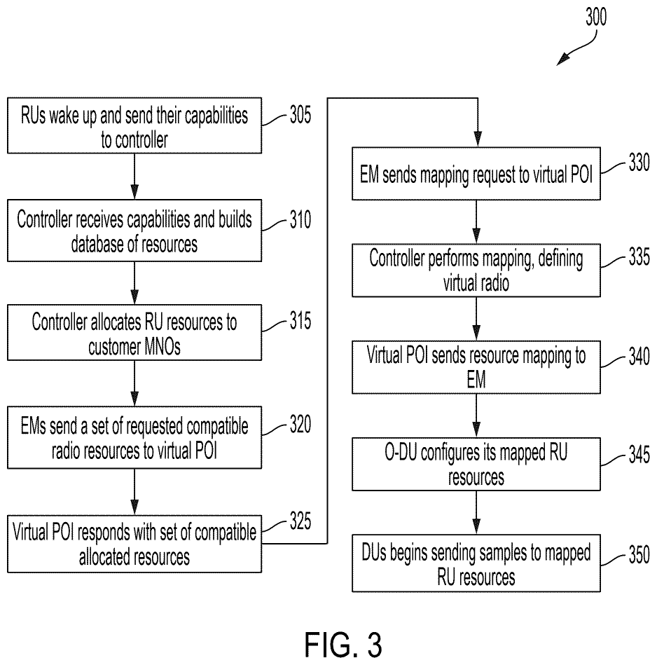

FIG. 3 illustrates an exemplary process 300 for configuring and operating RAN 100 according to the disclosure.

In step 305, each of the O-RUs 145 starts up and sends its capabilities to controller 105 over M-Plane network 160. The given O-RU 145's OAM 210 may send this information. The capabilities may include the following: supported frequency bands and channels within those frequency bands; the number of RF resource pools 230 that the O-RU 145 is capable of supporting; supported power levels at each frequency band; the number of antennas 147 and their locations; number of sectors, and MIMO capabilities. The O-RU 145's OAM 210 may have the IP (Internet Protocol) address of controller 105 in its own configuration information, or it may obtain the IP address of controller 105 via a DHCP (Dynamic Host Configuration Protocol) server. The protocol and format of the information sent by each O-RU 145 may be according to a “call home” procedure defined in the Netconf specification and adopted by the O-RAN specification.

In step 310, controller 105 receives the capabilities provided to it by each O-RU 145 and registers the O-RU 145, storing the capability information each O-RU 145 in a memory (not shown). This may be in the form of a database.

In step 315, controller 105 allocates the capabilities provided by each of the O-RUs 145 to each of the network operators. This may include assigning, for each frequency band supported by each O-RU 145, a set of distinct component carriers (frequency, bandwidth, and power level) to each network operator. Controller 105 may do this according to pre-arranged allocations based on contractual arrangements between each network operator and the neutral host. Controller 105 may also allocate capabilities according to a group policy. A group policy may include a preestablished priority list of which network operator is to be allocated additional resources: e.g., unlicensed spectrum, CBRS channels, etc., according to priority. The result of step 315 is a set of allocated radio resources, one set per network operator.

If a given O-RU 145 has a multiband transceiver 235 that supports band 48 (CBRS), then on receiving this information, controller 105 may reserve this CBRS capability for later activation by a given network operator. CBRS-specific channel activation is described below. Controller 105 may further allocate capabilities, such as CBRS channels, whereby a network operator may pay for priority (e.g., group policy).

Steps 320-340 may be considered sub-steps within a broader sub-process for defining and coupling a virtual radio 115 to a network operator via its element manager 130. Although these steps are described for a single network operator, through its element manager 130, it will be understood that it may apply to all the network operators and element managers 130.

Accordingly, steps 320-340 may be performed individually per network operator in sequence or may be performed in a batch such that each of step 320-340 may be simultaneously done for all the network operators.

In step 320, element manager 130 sends information regarding a set of requested compatible radio resources to virtual POI 110. The set of requested compatible radio resources may include information regarding specific cells requested by the network operator. In doing so, the element manager 130 may request a list of devices within the O-RUs 145 (e.g., bands, channels within bands, channel bandwidths, channel power levels, antennas, and antenna locations) that are compatible with its requested capabilities. In doing so, element manager 130 may invoke one or more APIs provided by virtual POI 110, thereby establishing a proprietary interface 150 between element manager 130 and virtual POI 110.

In step 325, controller 105 receives, via virtual POI 110, the set of requested compatible radio resources from element manager 130. Controller 105 then retrieves the set of allocated radio resources corresponding to element manager 130's network operator generated in step 315; identifies which of the set of allocated radio resources matches any of the set of requested compatible resources; and generates a set of compatible allocated radio resources. Controller 105 sends the set of compatible allocated radio resources to element manager 130. The set of compatible allocated radio resources generated in step 325 may be a subset of the set of allocated radio resources generated in step 315, or it may be a one-to-one match. The former may happen in the case that the element manager 130 is requesting less than the maximum radio resources that may be available to it. In this case, controller 105 retrieves only those allocated radio resources that match the requested compatible radio resourced provided by element manager 130 and may reserve the outstanding allocated radio resources for other uses, either by this network operator or by another network operator. The result of step 325 is a set of compatible allocated radio resources, which is a list of radio resources that controller 105 chooses to expose to that network operator, and which controller 105 sends to element manager 130 via virtual POI 110.

In step 330, element manager 130, having received the set of compatible allocated radio resources from controller 105, identifies which of the compatible allocated radio resources best match its requested compatible radio resources and sends a mapping request listing the identified matching radio resources to virtual POI 110. Here, the mapping request is for a set of selected allocated radio resources, which may be a subset of the compatible allocated radio resources generated by controller 105 in step 325, or it may be a one-to-one match.

In step 335, controller 105 receives the mapping request from each element manager 130, which includes the set of selected allocated radio resources. Having this information, controller 105 determines the device address for each of available RF resource pools 230 that may be configured for the selected allocated radio resources provided by element manager 130, defining a virtual radio 115 for that network operator. Accordingly, virtual radio 115 contains the following: an address for each allocated RF resource pool 230 across all compatible O-RUs 145 matching each of the set of selected allocated radio resources; a virtual serial number for each of the allocated RF resource pools 230 (described below); the frequency and bandwidth of the component carrier handled by that RF resource pool 230; the maximum power level for that RF resource pool 230; and the location of the antennas coupled to the RF resource pool 230 via the O-RU 145's multiband transceiver.

With this information, controller 105 sends commands to each O-RU 145's OAM 210, via M-Plane interface 120, to configure the appropriate RF resource pools 230 accordingly across each O-RU 145. The configuration commands performed by OAM 210 may include the following: assigning each RF resource pool 230 to a corresponding virtual radio 115; assigning an O-DU address to each RF resource pool 230; assigning a component carrier frequency and bandwidth to each RF resource pool 230; configuring, for each RF resource pool 230, the RF/baseband upconverter and downconverter hardware for the designated frequency of the component carrier assigned to that RF resource pool 230 according to the assigned virtual radio 115; and configuring each RF resource pool 230 to provide performance measurement information to OAM 210.

Controller 105 may allocate RF resource pools 230 within the same frequency band to two or more network operators. In this case, in defining the virtual radio 115 in step 335, controller 105 may reduce the power allocation to each network operator's virtual radio 115 to prevent clipping by the power amplifier being shared by multiple RF resource pools 230. For example, controller 105 may issue commands to the O-RU 145's OAM 210 to reduce the power level for the affected RF resource pools 230 by 3 dB or more. The extent of power reduction may be a function of the number of RF resource pools 230 coupled to the same power amplifier within multiband transceiver 235, and the capacity of the power amplifier. The extent and distribution of power reduction may be dictated by neutral host OSS 170, whereby neutral host OSS 170 may reduce the power differently to select RF resource pools 230 according to a power sharing scheme that may include predetermined priorities. It will be understood that such variations are possible and within the scope of the disclosure.

In step 340, controller 105, via virtual POI 110, sends the respective resource mapping of virtual radio 115 to element manager 130. At the completion of step 340, the element manager 130's O-DU 125 has the addresses it needs to configure the resources defined by its virtual radio 115 defined by controller 105 in step 335, and exchange downlink/uplink radio samples (in the form of 7.2x packets) to/from its RF resource pools 230 within each of the O-RUs 145 as expressed in its corresponding virtual radio 115.

As mentioned above, steps 320-340 may be repeated for each element manager 130, or steps 320-340 may be executed concurrently for multiple element managers 130. It will be understood that such variations are possible and within the scope of the disclosure.

It may be that one or more O-RUs 145 supports band 48 (CBRS), and controller 105 may have allocated one or more CBRS channels to a given O-DU 125 via its element manager 130. In this case, the mapping defined by virtual radio 115 provides an address or addresses for one or more RF resource pools 230 covering CBRS channels. In this case, the element manager 130 may invoke its CBRS domain proxy 140 to contact a SAS (Spectrum Allocation Service) to request a grant to use the CBRS channel. In doing so, element manager 130 may retrieve CBSD (CBRS Device)-related information from its virtual radio 115 regarding the location of the CBSD antennas, channel information, and allocated power levels. In this case, O-DU 125 must wait to receive a grant from the SAS via domain proxy 140 before it may begin sending samples to its allocated CBRS channel. The CBSD-related information may include a virtual serial number for each CBRS channel allocated to the network operator. For example, each O-RU 145's multiband transceiver 235 may have one or more hardware serial numbers, one per radio integral to the multiband transceiver 235. Controller 105 may obtain these serial numbers from OAM 210. A given network operator's virtual radio 115 may include one or more CBRS channels (RF resource pools 230 that are configured to operate in band 48). For each RF resource pool 230 configured to operate in band 48, controller 105 may retrieve the hardware serial number of the band 48 radio of the multiband transceiver 235 to which the RF resource pool 230 is coupled, and append that hardware serial number with an additional number, thereby generating a virtual serial number for RF resource pool 230 within virtual radio 115. For example, O-RU1 145a may have a band 48 radio in its multiband transceiver 235 that has a serial number 12345. For each RF resource pool 230 coupled to that radio, controller 105 may generate a virtual serial number (e.g., 12345-1, 12345-2, etc.) and store this information with the virtual radio 115 to which the given RF resource pool 230 is assigned.

Accordingly, each virtual radio 115 may have a plurality of virtual serial numbers, one for each CBRS channel allocated to that network operator. Controller 105 may do the same for each RF resource pool 230 operating in the other frequency bands, thereby generating a virtual serial number for each channel allocated to the network operator and defined by that network operator's virtual radio 115.

In step 345, network operator, through its element manager 130 and virtual POI 110, may configure the resources defined by its virtual radio 115. This may include turning a channel on/off; locking a cell; and setting power levels to distribute its allocated power among its channels, as long as total configured power does not exceed its maximum power dictated by controller 105 and set in its virtual radio 115. Element manager 130 may relay this configuration information to virtual POI in the form of configuration commands from O-DU 125. Controller 105, having received these configuration commands, may relay them to the OAM module 210 of the appropriate O-RU 145.

In step 350, each O-DU 125 may begin operation by sending samples to and receiving samples from its virtual radio-defined resources within RAN 100.

Controller 105 may handle all alarms and performance measurements occurring within the O-RUs 145. As discussed above, each O-RU 145 has an OAM module 210 that receives any alarms generated by its multiband transceiver 235 and performance measurement information from each RF resource pool 230 over data connection 212. OAM module 210 transmits this information to controller 105 via M-Plane interface 120 (and intervening network). Controller 105 may then relay this information to the appropriate element manager(s) 130 via virtual POI 110.

In defining a virtual radio 105, controller 105 may allocate the entire bandwidth of a component carrier or channel assigned to a particular network operator via virtual radio 115. However, the network operator may choose to use only an initial bandwidth part within the channel. In this case its element manager 130 may invoke an API to request reconfiguring its virtual radio 115 to only use an initial bandwidth part. For example, the fully allocated channel may have a 100 MHz bandwidth, but the network operator may only want to use 20 MHz of that channel to reduce power consumption on behalf of itself as well as its connected customer UEs (User Equipment). In this case, the network operator may wish to limit the bandwidth to an initial 20 MHz bandwidth part and reserve the rest of the 100 MHz bandwidth for further use in the case of additional UE traffic demand. In implementing this, controller 105, receiving this request from the network operator's element manager 130 through virtual POI 110, may send the appropriate commands via M-Plane interface 120 to the OAM 210 of the intended O-RU 145 to reduce its corresponding RF resource pool 230's bandwidth accordingly. Later, depending on UE traffic volume, the network operator's element manager 130 may request activation of a new bandwidth part that has a greater bandwidth, via its virtual radio 115. In response, controller 105 may issue the appropriate commands via M-Plane interface 120 to OAM 210 within the appropriate O-RU 145 to activate a replacement bandwidth part within the corresponding RF resource pool 230. This replacement bandwidth part may encompass up to the 100 MHz bandwidth available to that network operator.

In a variation to process 300, a simpler sub-process for defining and coupling a virtual radio 115 to a network operator's O-DU 125 via its element managers 130 (described in steps 320-340) is possible and within the scope of the disclosure. In a simplified sub-process, for each network operator, element manager 130 may send a set of requested compatible radio resources to controller via virtual POI 110, as disclosed above with respect to step 320. In response, controller 105 may identify which of its allocated resources are compatible with the requested compatible resources, generate a mapping that defines a virtual radio 115 (as described above with respect to step 335), and send the mapping information for the virtual radio 115 to element manager 130 (as described above with respect to step 340). In a further variation, element manager 130 may simply request a mapping to its allocated radio resources, for which controller 105 responds with a mapping of the allocated radio resources generated in step 315, defining a virtual radio 115. It will be understood that such variations are possible and within the scope of the disclosure.

In the example described above, each element manager 130 is coupled to a CBRS domain proxy 140, through which it contacts the SAS (Spectrum Allocation Service-not shown) to request grants for CBRS channel access. In a variation, virtual POI 110 may be coupled to a neutral host domain proxy (not shown) through which controller 105 may request CBRS channel access on behalf of the network operators. It will be understood that such variations are possible and within the scope of the disclosure.

Although the above exemplary RAN 100 is described in the context of the context of an O-RAN implementation, it will be understood that the disclosure may also apply to other RAN technologies, provided that the RAN hosts multiple network operators, each of which are to be allocated resources among a plurality of radio remote units over a packetized digital fronthaul network. It will be understood which features would be required and what modifications would be necessary to implement a non-O-RAN version of RAN 100.

1. A method for configuring a multi-operator RAN (Radio Access Network) that comprises a plurality of remote units, a controller and a plurality of distribued units, each corresponding to one of a plurality of network operators, the method comprising:
receiving a set of capabilities for each of the plurality of remote units;
allocating radio resources from each set of capabilities of the plurality of remote units, across each of the plurality of network operators to define a set of allocated radio resources for each of the network operators;
defining and coupling a virtual radio to each of a plurality of element managers, wherein each element manager is coupled to a corresponding one of the plurality of distributed units; and
configuring each of the remote units to couple to each of the plurality of distributed units in accordance with the plurality of virtual radios.

2. The method of claim 1, wherein the set of capabilities comprises:
one or more supported frequency bands;
one or more supported channels within each frequency band; and
a channel bandwidth for each of the supported channels.

3. The method of claim 2, wherein the set of capabilities further comprises a number of antennas and their respective locations.

4. The method of claim 1, wherein the defining and coupling a virtual radio to each of a plurality of element managers comprises:
receiving, from an element manager, a request for a set of requested compatible radio resources;
sending, to the element manager, a set of compatible allocated radio resources corresponding to the element manager;
receiving, from each element manager, a request for a mapping of a set of selected allocated radio resources;
generating virtual radio information based on each mapping request; and
sending corresponding virtual radio information to each element manager.

5. The method of claim 4, wherein the set of requested compatible radio resources is a subset of set of compatible allocated radio resources.

6. The method of claim 4, wherein the set of compatible allocated radio resources is a subset of the requested compatible radio resources.

7. The method of claim 4, wherein the virtual radio information comprises:
an address for each of a plurality of allocated RF resource pools;
a frequency for each of the plurality of allocated RF resource pools;
a bandwidth for each of the plurality of allocated RF resource pools; and
a power level for each of the plurality of allocated RF resource pools.

8. The method of claim 7, wherein the virtual information further comprises a virtual serial number for each of the plurality of allocated RF resource pools.

9. The method of claim 7, wherein the configuring each of the remote units to couple to each of the plurality of distributed units in accordance with the plurality of virtual radios comprises:
providing a distributed unit address for each of the plurality of allocated RF resource pools;
setting the frequency for each of the plurality of allocated RF resource pools;
setting the bandwidth for each of the plurality of allocated RF resource pools; and
setting the power level for each of the plurality of allocated RF resource pools.

10. The method of claim 8, wherein the providing a distributed unit address for each of the allocated RF resource pools comprises storing the distributed unit address in a multi-DU resource mapper module.

11. The method of claim 4, further comprising:
receiving, from an element manager, configuration commands from a corresponding distributed unit; and
relaying the configuration commands to one or more remote units.

12. The method of claim 10, wherein the relaying configuration commands comprises transmitting the configuration commands to one or more remote units over an M-Plane interface.

13. The method of claim 10, wherein the configuration commands comprises:
turning on a cell;
locking a cell; and
setting a cell power level.

14. The method of claim 1, wherein the defining and coupling a virtual radio to each of a plurality of element managers comprises:
receiving, from an element manager, a set of requested compatible resources;
generating a mapping that defines a virtual radio based on the requested compatible resources; and
sending, to the element manager, the mapping that defines a virtual radio.

15. The method of claim 1, wherein the defining and coupling a virtual radio to each of a plurality of element managers comprises:
receiving, from an element manager, a request for a mapping that defines a virtual radio;
generating a mapping that defines a virtual radio based on the set of allocated radio resources corresponding to the element manager; and
sending, to the element manager, the mapping that defines a virtual radio.

16. The method of claim 1, wherein the defining and coupling a virtual radio to each of a plurality of element managers comprises generating a plurality of virtual serial numbers, each corresponding to a radio resource within the set of allocated radio resources.

17. A method for configuring a remote unit in a multi-operator radio access network, comprising:
receiving a plurality of configuration commands from a controller, the configuration commands for configuring each of a plurality of RF (Radio Frequency) resource pools; and
receiving a distributed unit address for each of the plurality of RF resource pools.

18. The method of claim 17, wherein the plurality of configuration commands comprises one or more of:
assigning each RF resource pool 230 to a corresponding virtual radio;
assigning an O-DU address to each RF resource pool;
assigning a component carrier frequency and bandwidth to each RF resource pool;
configuring, for each RF resource pool, the RF/baseband upconverter and downconverter hardware for the designated frequency of the component carrier assigned to that RF resource pool 230 according to the assigned virtual radio; and
configuring each RF resource pool to provide performance measurement information to an operation and management module.

19. The method of claim 17, further comprising receiving a second distributed unit address for a first RF resource pool within the plurality of RF resource pools.

20. The method of claim 19, wherein the plurality of configuration commands further comprises:
assigning a first distribute unit address to a first resource block to a resource grid within the first RF resource pool, the first distributed unit address corresponding to a first network operator; and
assigning the second distributed unit address to a remaining plurality of resource blocks to the resource grid within the first RF resource pool, the second distributed unit address corresponding to a second network operator.
